(19) United States
(12) Patent Application Publication
(10) Pub. No.: US 2015/0210047 A1
(43) Pub. Date: Jul. 30, 2015

(54) ARTICLES HAVING IMPROVED SURFACE ADHESION AND METHODS OF MAKING THE SAME

(71) Applicant: Inhance Technologies, LLC, Houston, TX (US)

(72) Inventors: Subramanian Easwaran Iyer, Houston, TX (US); Bernard D. Bauman, Fulshear, TX (US); Charles N. Myer, Houston, TX (US)

(73) Assignee: Inhance Technologies LLC, Houston, TX (US)

(21) Appl. No.: 14/603,402

(22) Filed: Jan. 23, 2015

Related U.S. Application Data
(60) Provisional application No. 61/931,221, filed on Jan. 24, 2014.

(51) Int. Cl. B32B 27/08; B32B 27/32; B32B 27/40; B32B 27/38; B29C 49/00; B29C 41/04; B29C 47/02; B29C 45/00; B29C 43/30; C08F 110/02; B29C 65/70

(52) U.S. Cl. CPC B32B 27/08; C08F 110/02; B32B 27/32; B32B 27/40; B32B 27/38; B29C 65/70; B29C 41/042; B29C 47/025; B29C 45/00; B29C 43/305; B29C 49/0015; B32B 2250/02; B32B 2250/24; B32B 2266/0278; B29K 2023/00

(57) ABSTRACT

A multi-layer article includes a first layer that includes a first polyolefin resin powder and a second polyolefin resin powder that has been treated with a fluorine reaction gas. The multi-layer article also includes a second layer adhered to the first layer.

### RELATED APPLICATIONS

This application claims priority to U.S. Provisional Patent Application No. 61/931,221, filed on Jan. 24, 2014.

### FIELD OF INVENTION

The present disclosure relates to an article with improved surface adhesion properties. More specifically, this disclosure relates to articles having improved surface adhesion properties that are formed of a blend of polymeric resins, at least one of which has been treated with a fluorine containing reaction gas.

### BACKGROUND

Generally, polyolefin (or polyalkene) resins, such as low density polyethylene (LDPE), linear low density polyethylene (LLDPE), high density polyethylene (HDPE), and polypropylene (PP) have very low surface energies and are highly hydrophobic. Therefore, in order to apply a polar coating or second layer to articles formed from these resins, the surface of the articles must be modified in order to increase.

Known methods of surface modification, such as plasma, flame, or corona treatment of the article, are difficult to apply and generally impart only a temporary change to the article's surface. Therefore, these methods are typically not used on resins in commercial settings. And, the use of sprays, wipes or other adhesive coatings are expensive, time consuming, and often require the use of undesirable volatile organic compounds (VOCs). It would be beneficial to create a polyolefin article with an outer surface that may be permanently adhered to a secondary coating or layer without the use of a tie or adhesive layer in between.

### SUMMARY OF THE INVENTION

An article may be made of a polymeric resin powder, such as a polyolefin, or a combination of polymeric resin powders. In one embodiment, the article may be made by blending a first polyolefin resin powder that has been treated with a fluorine reaction gas and a second, untreated, polyolefin resin powder and forming the blended resin powders into an article having improved surface adhesion properties. A second layer—or coating—may then be applied to the article.

### DETAILED DESCRIPTION

Polyolefin resin powders may be used to create various molded articles and films. For ease of reference, a molded plastic article will be described, but it should be understood that other processes and things may be created using the process and polymers described herein. In one embodiment a rotational-molded (or roto-molded) plastic article with improved surface adhesive properties may be formed by providing a heated hollow mold which is filled with a polyolefin resin powder, or combination of resin powders. The mold is then slowly rotated (usually around two or three axes) causing the softened material to disperse and stick to the walls of the mold. In order to maintain even thickness throughout the article, the mold continues to rotate at all times during the heating phase and to avoid sagging or deformation also during the cooling phase.

It should be appreciated that the articles may also be formed using other acceptable processes, such as blow molding, compression molding, injection molding, thermoform, or film casted.

The base article may be made from a polyolefin resin powder, such as low density polyethylene, linear low density polyethylene, high density polyethylene, or polypropylene. Examples of suitable resin powders include, but are not limited to polyolefin homopolymers, copolymers, compounded polypropylene elastomers, or thermoplastic polyolefin elastomers. They resin powder may be clarified and nucleated.

The polyolefin resin powder is exposed to a fluorine containing reaction gas to create a treated polyolefin resin powder. The reaction time for the process may be from about one second to about two hours. Once treated, the treated polyolefin resin powder may be combined with a second, untreated, resin powder or may be used by itself to form the article. If a second resin is used, it may be the same resin powder or may include a different polyolefin. In one embodiment, the article may include from 0% to about 100% of the treated polyolefin resin powder. In another embodiment, the article may include from about 10% to about 30% of the treated polyolefin resin powder.

The treated polyolefin resin powder, or combination of treated and untreated polyolefin resin powders, are then formed into an article, as described above. The resulting article may generally have increased surface adhesion properties as compared to an article created from the untreated polyolefin resin powder alone. And thus, able to adhere to substances that typically have a high surface energy.

Once formed, the article is then coated with, or adhered to, a second (or coating) layer. The second layer may include substances with naturally occurring high energy surfaces. Examples of substances with high energy surfaces include, but are not limited to urethane, epoxy, unsaturated polyester, or polyurethane materials.

### EXAMPLES

In one example, eight samples of linear low density polyethylene (LLDPE) resin powder were dispersed onto a moving belt in a very thin layer. The samples traveled through a treatment chamber at a rate of 30 feet/minute (12 second exposure time) or 60 feet/second (6 second exposure time). The samples were exposed to a fluorine containing reaction gas including about 20% fluorine and 80% nitrogen that was introduced into the treatment chamber at a rate of 25 cubic feet/minute. A vacuum was applied to the ends of the chamber to prevent the reaction gas from existing the chamber. The exhaust from the vacuum was scrubbed free of hazardous gases.

The eight treated samples and a control sample were prepared as set forth below in Table I:

TABLE I

| Sample Material | Sample # |
|---|---|
| Untreated | Control |
| 12 seconds gas exposure | |
| 25/75 treated/untreated | 1 |
| 50/50 | 2 |
| 75/25 | 3 |
| 100% treated | 4 |
| 6 seconds gas exposure | |
| 25/75 treated/untreated | 5 |
| 50/50 | 6 |
| 75/25 | 7 |
| 100% treated | 8 |

The surface energy for the control sample and the eight treated sample resin powders was then measured using a Dyne fluid absorption procedure. Approximately five (5) grams of resin powder was placed in a small cup so that the resin powder had a level surface. A drop of dyne fluid was dispensed onto the resin powder. If the fluid was absorbed into the powder within 10 seconds, the surface energy of the powder was considered to be equal or less than the fluid itself. The highest surface energy dyne fluid that was absorbed in 10 seconds or less was considered equal to the surface energy of the powder. The results of the powder dyne absorption testing is set forth in Table II:

TABLE II

| | Powder Dyne |
|---|---|
| Sample | absorption |
| Control | 38 |
| 1 | 38 |
| 2 | 42 |
| 3 | 46 |
| 4 | 56 |
| 5 | 40 |
| 6 | 46 |
| 7 | 48 |
| 8 | 56 |

As shown in Table II, as the percentage of treated polyolefin resin in the sample increased, so too did the surface energy.

After the surface energy of the powder samples was measured, the samples were then formed into a film. In order to create the films, a Carver press was equilibrated at 400° F. One gram of each powder was then spread onto a piece of foil. Another piece of foil was then placed on top of the powder and the components were placed on the press. 100 lbs of force was then applied to each sample for three minutes. At the end of three minutes, the pressure was released and the samples were removed from the press and cooled.

The surface adhesion properties of the pressed film samples were then tested by spreading a urethane foam onto each sample and allowing it to cure for 24 hours. The peel strength of the samples was then measured on a scale of 0 (representing no adhesion) to 5 (representing a strongly adhered foam). The results of the adhesion testing is set forth in Table III:

TABLE III

| | Adhesion of |
|---|---|
| | compressed film to |
| Sample # | urethane foam |
| Control | 0 |
| 1 | 1 |
| 2 | 3 |
| 3 | 4 |
| 4 | 4 |
| 5 | 1 |
| 6 | 4 |
| 7 | 4 |
| 8 | 5 |

As shown in Table III, as the percentage of treated resin powder in the sample increased, so too did the adhesion of the pressed film to the urethane foam.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Additionally, to the extent that the terms “on” or “onto” are used in the specification or the claims, it is intended to additionally mean “in,” “into,” or “near.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A multi-layer article comprising:
a first layer comprising a first polyolefin resin powder, wherein the first polyolefin resin powder is treated with a fluorine reaction gas to create a treated resin powder that may be formed in to an article; and
a second layer adhered to the first layer to form the multi-layer article.

2. The multi-layer article of claim 1, wherein the first layer further comprises an untreated resin powder blended with the treated resin powder.

3. The multi-layer article of claim 2, wherein the first layer comprises from about 10% to about 99% treated resin and from about 1% to about 90% untreated resin.

4. The multi-layer article of claim 3, wherein the first layer comprises from about 10% to about 30% treated resin and from about 70% to about 90% untreated resin.

5. The multi-layer article of claim 1, wherein the first polyolefin resin powder is selected from the group consisting of low density polyethylene, linear low density polyethylene, high density polyethylene, and polypropylene.

6. The multi-layer article of claim 2, wherein the first polyolefin resin powder is linear low density polyethylene.

7. The multi-layer article of claim 5, wherein the second layer is selected from the group consisting of urethane foam, epoxy, unsaturated polyester, and polyurethane.

8. The multi-layer article of claim 1, wherein the first polyolefin resin powder is treated by exposing the first resin powder to the fluorine reaction gas for about one second to about two hours.

9. The multi-layer article of claim 1, wherein the reaction gas comprises about to about 20% fluorine and about 80% nitrogen.

10. A method of forming a multi-layer article comprising:
treating a first polyolefin resin powder with a fluorine containing reaction gas;
blending the first polyolefin resin powder with a second resin powder to make a blended resin powder;
forming the blended resin powder into a first layer;
adhering a second layer to the first layer to form the multi-layer article.

11. The method of claim 10, wherein the first layer is formed by roto-molding, film extrusion, injection molding, compression molding, or blow molding.
